(19) United States
(12) Patent Application Publication
(10) Pub. No.: US 2026/0137192 A1
(43) Pub. Date: May 21, 2026

(54) TWO-PART ARTIFICIAL NAIL

(71) Applicant: ZHONGSHAN SENBOMA ARTWARE PTE. LTD., Singapore (SG)

(72) Inventor: Yong CHEN, Vancouver (CA)

(21) Appl. No.: 18/952,467

(22) Filed: Nov. 19, 2024

(51) Int. Cl. A45D 31/00; C08K 5/12; C08K 5/526; C08L 55/02; C08L 69/00

(52) U.S. Cl. CPC A45D 31/00; C08K 5/12; C08K 5/526; C08L 55/02; C08L 69/00; C08K 2201/014; C08L 2201/08

(57) ABSTRACT

A two-part artificial nail includes a decoration part and a body part, each of which is formed using a respective molding process. The decoration part is made from a first mixture, which has a first melting temperature and may include one or more resin polymers. Following the formation of the decoration part, the body part is made from a second mixture, which has a second melting temperature lower than the first melting temperature, and may also include one or more resin polymers. The two-part artificial nail exhibits an enhanced wear resistance, and also prevents the color cross problem that is commonly seen in conventional artificial nails.

### TECHNICAL FIELD

The present disclosure generally relates to techniques of manicure decoration and, more particularly, to a two-part artificial nail and a manufacturing process thereof.

### BACKGROUND

Artificial nails are a type of manicure decoration that has emerged in recent years. Most artificial nails currently on the market are made of plastic materials through an injection molding process. Typically, various kinds of nail bodies, each normally exhibiting a single color, are firstly made using corresponding various kinds of injection molds via the injection molding process. Additional decorations or design features are subsequently added or otherwise post-processed to the nail bodies using techniques such as spraying, painting, two-dimensional printing, and/or three-dimensional additive printing, especially around the tip portion or the top surface of the nail bodies, resulting in finished artificial nails. The finished artificial nails may be bonded or otherwise attached to the top surface of human nails using adhesives such as jelly glue, pressure sensitive glue, or quick drying glue.

Artificial nails made by the single injection molding process as describe above, however, suffer a major disadvantage of relatively poor wear resistance, especially around the tip portion thereof. The disadvantage would negatively affect not only the aesthetics of wearing, but also the expected life span of the artificial nails.

### SUMMARY

In the present disclosure, a two-part artificial nail is provided, along with a method of making the same. The artificial nail has two parts that are assembled together or otherwise mutually engaged, with each part made using a respective molding step of the method. For instance, a second part of the artificial nail may be made additively to, or following the making of, a first part of the artificial nail. Moreover, the two parts may be made in the same or different colors, and of the same or different materials, with each part having respective desired properties or features. In an event that the two parts are made in different colors, a dual-color or two-tone artificial nail is achieved.

In one aspect, a two-part artificial nail implementable to a human finger is provided. The artificial nail includes a body part, as well as a decoration part that is bonded to the body part. The decoration part may be made from a first mixture of ingredients, which may include a first kind of resin polymer and a filler. In some embodiments, the first mixture may also include a second kind of resin polymer, a coupling agent, and/or an antioxidant. The body part may be made from a second mixture of ingredients, which may include a third kind of resin polymer and a toughening agent. In some embodiments, the second mixture may also include a fourth kind of resin polymer, a coupling agent, and/or an antioxidant. Coloring agents may be included in the first and/or second mixtures for realizing desired colors and aesthetical effects of the body part and the decoration part.

Each of the body part and the decoration part of the two-part artificial nail may be made using a respective molding process. The first mixture of ingredients may melt at a first melting temperature, at which the mixture becomes suitable for the corresponding molding process. Likewise, the second mixture of ingredients may melt at a second melting temperature. In some embodiments, the second melting temperature may be different from, and lower than, the first melting temperature. The resulting body part and the decoration part of the two-part artificial nail may differ in some physical properties, e.g., a flexural modulus thereof. In some embodiments, the body part may have a lower value of flexural modulus than the decoration part. Namely, the body part may be “softer” or “more flexible” in physical flexibility than the decoration part.

In another aspect, a method of making the two-part artificial nail is provided. The method may involve melting the first mixture and then forming the decoration part from the melted first mixture using a first molding process. The method may also involve melting the second mixture and then forming the body part from the melted second mixture using a second molding process. Each of the first and second molding processes may be a process of extrusion molding or injection molding. The two molding processes may use a same mold, or two different molds. In some embodiments, the body part is formed with the decoration part already formed and placed in the mold. Namely, the body part is additively formed onto the already formed decoration part, thereby bonding the two parts together to form the integral artificial nail. In some embodiments, the body part and the decoration part are molded separately and bonded together to form the two-part artificial nail.

The two-part artificial nail according to embodiments of the present disclosure substantially prevents the color cross problem that is commonly seen in other artificial nails. Furthermore, the two-part artificial nail of the present disclosure exhibits an enhanced wear resistance compared to the artificial nails made according to conventional processes.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIGS. 1A through 1D illustrate examples artificial nail in accordance with an implementation of the present disclosure.

FIGS. 2A and 2B illustrate examples artificial nail in accordance with an implementation of the present disclosure.

FIGS. 3A through 3D illustrate examples artificial nail in accordance with an implementation of the present disclosure.

FIG. 4 is a flowchart of an example process in accordance with an implementation of the present disclosure.

### DETAILED DESCRIPTION OF THE PREFERRED EMBODIMENTS

A two-part artificial nail according to the present disclosure is further explained and described below with reference to the accompany drawings. The two-part artificial nail not only exhibits an enhanced wear resistance, but also alleviates or prevents an otherwise common problem of color cross between various colors presented on an artificial nail.

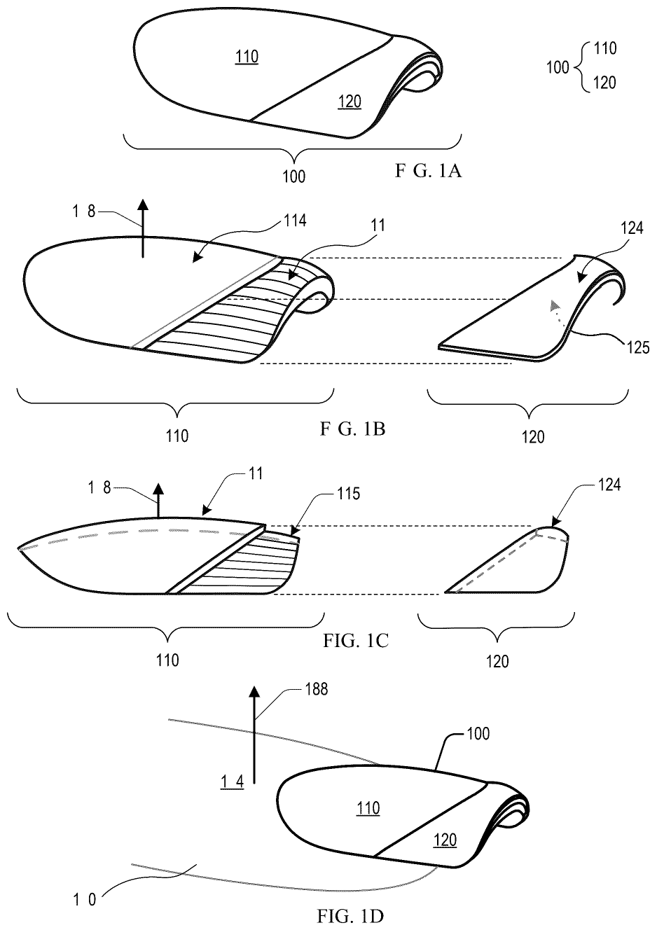

Referring to FIGS. 1A through 1D, a two-part artificial nail 100 according to the present disclosure may include a first part, which comprises a body part 110 of the artificial nail 100, as well as a second part, which comprises a decoration part 120 of the artificial nail 100. FIG. 1A illustrates a perspective view of the artificial nail 100, whereas FIG. 1D illustrates a perspective view of the artificial nail 100 being worn on, or otherwise attached to, a human finger 180. As shown in FIGS. 1A through 1D, the two parts 110 and 120 of the artificial nail 100 are bonded or otherwise engaged with one another to form the integral artificial nail 100. FIG. 1B illustrates an exploded view of the perspective view of FIG. 1A, and FIG. 1C, which is a side view (i.e., viewed from a side of the human finger 180) of FIG. 1B. As shown in FIGS. 1B and 1C, the decoration part 120 may be engaged with the body part 110 by sitting, at least partially, on a bonding area 115 of the body part 110. The bonding area 115 may include a curved surface of the body part 110, and the curvature of the curved surface maybe the same as the curvature of a corresponding inner surface 125 of the decoration part 120 such that a substantially exact fitting between parts 110 and 120 may be achieved at an interface between the bonding area 115 and the inner surface 125. Also illustrated in FIGS. 1B and 1C is that, the bonding area 115 may include a region that is recessed with respect to a top surface 114 of the body part 110.

Various embodiments of the artificial nail of the present disclosure may have the decoration part 120 positioned differently with respect to the body part 110. Namely, a top surface 124 of the decoration part 120 may be made substantially higher than, flush with, or lower than the top surface 114 of the body part 110. For example, in a vertical direction 188 that is substantially normal to and away from a top surface 184 of the human finger 180 (or, equivalently, normal to and away from the top surface 114 of the body part 110), the decoration part 120 may be positioned further away from the top surface 184 of the human finger 180 than the body part 110 is, such that the top surface 124 of the decoration part 120 is substantially higher than the top surface 114 of the body part 110 in the vertical direction 188. In another example embodiment, the decoration part 120 may be positioned closer to the top surface 184 of the human finger 180 than the body part 110 is, such that the top surface 124 of the decoration part 120 is substantially lower than the top surface 114 of the body part 110 in the vertical direction 188. In yet another example embodiment, in the vertical direction 188, the decoration part 120 may be positioned such that the top surface 124 of the decoration part 120 is substantially flush with the top surface 114 of the body part 110. The various example embodiments may be achieved by different thickness of the decoration part 120 as compared to the height of the recess of the boding area 115 relative to the top surface 114. For example, in an event that the thickness of the decoration part 120 (i.e., the distance between the top surface 124 and inner surface 125) is larger than the height of the recess of the boding area 115, the top surface 124 of the decoration part 120 would end up higher than the top surface 114 of the body part 110 in the vertical direction 188 after the two parts are bonded to form the integral artificial nail 100.

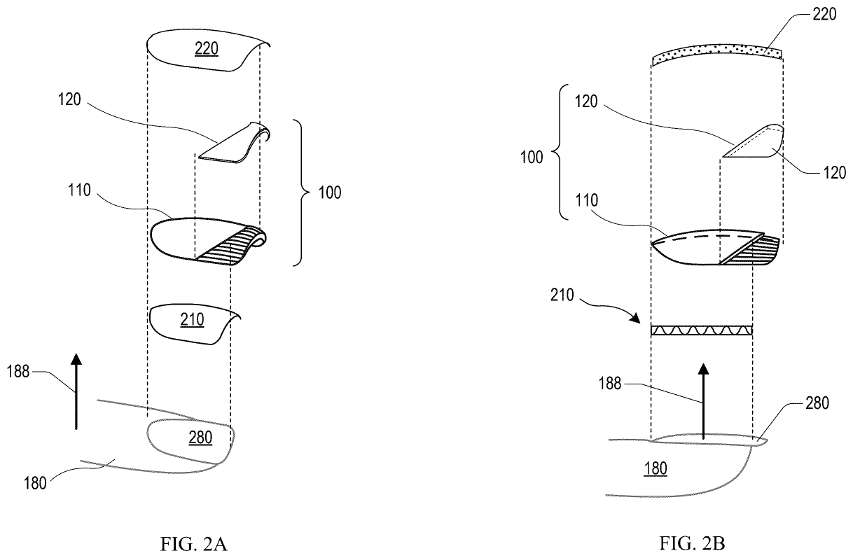

FIGS. 2A and 2B illustrate how the artificial nail 100 may be worn by the human finger 180. Specifically, FIG. 2A [with similar changes throughout] illustrates an exploded view of FIG. 1D, whereas FIG. 2B provides a side view of FIG. 2A (i.e., viewed from a side of the human finger 180, perpendicular to the direction 188). As shown in the exploded views of FIGS. 2A and 2B, the artificial nail 100 may be attached to the human finger 180 by bonding the body part 110 of the artificial nail 100 to a human nail 280 of the human finger 180 using adhesive or glue, which is represented by an adhesive layer 210. Subsequently, a protective layer 220, usually transparent or translucent, maybe employed or otherwise applied on top of the artificial nail 100 after the artificial nail 100 has been attached to the human finger 180. The protective layer 220 may provide extra protection to the artificial nail 100 against usage abrasion, thereby prolonging its service time or lifespan. The protective layer 220 may also serve an additional purpose of strengthening the engagement between the body part 110 and the decoration part 120 by holding the two parts together more strongly.

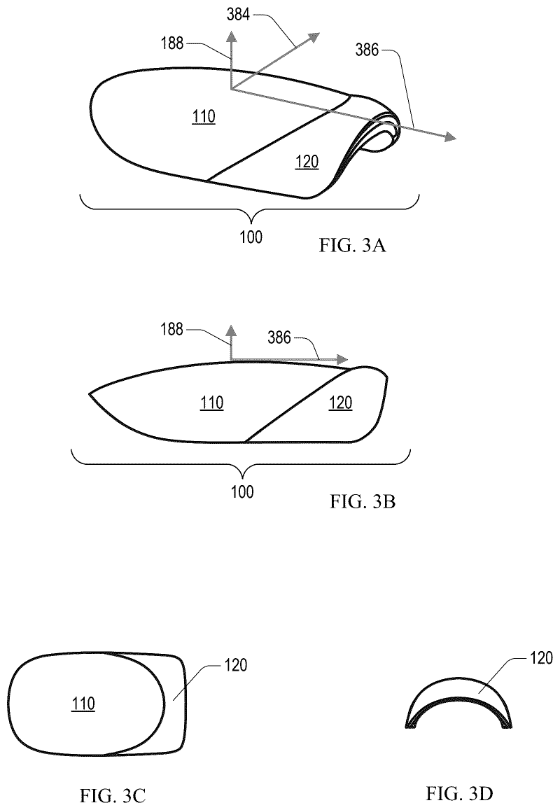

FIGS. 3A through 3D illustrate a perspective view, a side view, a top view, and a front view, respectively of the artificial nail 100, wherein a three-dimensional Cartesian coordinate system is defined using a direction 384, a direction 386 and the direction 188 that are mutually orthogonal. Specifically, when the artificial nail 100 is worn on the human finger 184 as shown in FIG. 1D, the side view shows the artificial nail 100 viewed from a side of the human finger 184 (i.e., in the direction 384); the top view shows the artificial nail 100 viewed from a top side of the human finger 184 (i.e., opposite to the direction 188); the front view shows the artificial nail 100 viewed towards the fingertip of the human finger 184 (i.e., towards the opposite direction of the direction 386).

As described in further detail below, the body part 110 and the decoration part 120 may have different material compositions (i.e., made from different ingredients or chemicals) to achieve different properties, which collectively contribute to an optimal performance of the artificial nail 100. Preferably, the body part 110 is desired to exhibit a softer, or more flexible physical property, as compared to the decoration part 120, to increase wearing comfort, whereas the decoration part 120 is desired to exhibit a harder, or more stiff physical property, as compared to the body part 110, to provide an enhanced resistance to usage abrasion. A composition listed in Table 1 below may be employed to produce a body part 110 with a desired softness, whereas a composition listed in Table 2 below may be employed to produce a decoration part 120 with a desired hardness.

The first part (i.e., the body part 110) of the artificial nail 100 may include ingredients listed in the following table (i.e., Table 1), which shows corresponding parts by weight of each ingredient for forming the body part 110.

TABLE 1

| Ingredients (body part) | Parts by weight | |
|---|---|---|
| Resin (Polymer) A | 55-95 | parts |
| Resin (Polymer) B | 5-45 | parts |
| Toughening agent | 2-10 | parts |
| Coupling agent | 2-10 | parts |
| Antioxidant | 0.3-1.0 | parts |

The second part (i.e., the decoration part 120) of the artificial nail 100 may include ingredients listed in the following table (i.e., Table 2), which shows corresponding parts by weight of each ingredient for forming the decoration part 120.

TABLE 2

| Ingredients (decoration part) | Parts by weight | |
|---|---|---|
| Resin (Polymer) C | 55-95 | parts |
| Resin (Polymer) D | 5-45 | parts |
| Filler | 3-30 | parts |
| Coupling agent | 2-10 | parts |
| Antioxidant | 0.3-1.0 | parts |

Referring to Table 1, each of the polymer A and polymer B of the body part 110 may be one or more of the following nine materials: (1) acrylonitrile butadiene styrene (ABS) typically having a melting temperature of 200-250 degrees Celsius (° C.) and a flexural modulus of 2000-2500 megapascal (MPa); (2) acrylonitrile styrene (AS) typically having a melting temperature of 200-270° C. and a flexural modulus of 2000-2600 MPa; (3) polymethyl methacrylate (PMMA) typically having a melting temperature of 165-200° C. and a flexural modulus of 2700-3200 MPa; (4) polyethylene (PE) typically having a melting temperature of 190-240° C. and a flexural modulus of 1500-2000 MPa; (5) polyamide (PA) typically having a melting temperature of 215-275° C. and a flexural modulus of 2500-3200 MPa; (6) polystyrene (PS) typically having a melting temperature of 185-215° C. and a flexural modulus of 2000-3000 MPa; (7) thermoplastic polyurethane (TPU) typically having a melting temperature of 170-205° C. and a flexural modulus of 1000-1300 MPa; (8) thermoplastic elastomer (TPE) typically having a melting temperature of 170-210° C. and a flexural modulus of 1000-1800 MPa; and (9) thermoplastic rubber (TPR) typically having a melting temperature of 150-210° C. and a flexural modulus of 1000-2400 MPa.

Referring to Table 2, each of the polymer C and polymer D of the decoration part 120 may be one or more of the following seven materials: (1) polycarbonate (PC) typically having a melting temperature of 280-310° C. and a flexural modulus of 2400-3000 MPa; (2) acrylonitrile butadiene styrene (ABS) typically having a melting temperature of 200-250° C. and a flexural modulus of 2000-2500 MPa; (3) acrylonitrile styrene (AS) typically having a melting temperature of 200-270° C. and a flexural modulus of 2000-2600 MPa; (4) polymethyl methacrylate (PMMA) typically having a melting temperature of 165-200° C. and a flexural modulus of 2700-3200 MPa; (5) polyethylene (PE) typically having a melting temperature of 190-240° C. and a flexural modulus of 1500-2000 MPa; (6) polyamide (PA) typically having a melting temperature of 215-275° C. and a flexural modulus of 2500-3200 MPa; and (7) polystyrene (PS) typically having a melting temperature of 185-215° C. and a flexural modulus of 2000-3000 MPa.

It is to be noted that, in the description above regarding the material properties, the melting temperature of each polymer indicates a temperature exceeding which the polymer becomes soft and able to be molded, shaped or otherwise treated using a corresponding injection or extrusion molding process.

It is also to be noted that, in the description above regarding the material properties, the flexural modulus is described as the flexural modulus obtained with standard specimen size, such as the specimen size stated in international ASTM D790 standard.

Referring to Table 2, the filler may include one or more of calcium carbonate, talcum powder, and barium sulfate. In some embodiments, a filler material of nanometer scale particle size may be preferred.

Referring to Table 1, the toughening agent may include one or more of dioctyl phthalate (DOTP), acetyl tributyl citrate (ATBC), and chlorinated polyethylene (CPE).

The coupling agent in Table 1 may be MBS copolymer, i.e., a copolymer made based on methyl methacrylate (MMA), butadiene, and styrene. Likewise, preferably, the coupling agent in Table 2 may also be MBS copolymer.

The antioxidant in Table 1 may include tris(2,4-di-tert-butylphenyl) phosphite, N,N-Hexamethylene bis(3,5-ditert-butyl-4-hydroxyphenyl propionamide), or both. Likewise, preferably, the antioxidant in Table 2 may include tris(2,4-di-tert-butylphenyl) phosphite, N,N-Hexamethylene bis(3,5-ditert-butyl-4-hydroxyphenyl propionamide), or both.

A method (hereinafter, “Method A”) of making the two-part artificial nail 100 is described next, wherein the body part 110 and the decoration part 120 may be made separately, and in some cases simultaneously, before the two parts are engaged together to produce the artificial nail 100. Method A may include the following steps:
Step A1. Mix the ingredients of Table 2 into a first mixture; heat up the first mixture until the first mixture reaches a first melting temperature and melts; with a first mold, form the melted first mixture into the decoration part 120 of the two-part artificial nail 100 via a process of extrusion or injection molding which is operated at a first molding temperature. Preferably, the first molding temperature is kept substantially the same as or above the first melting temperature.
Step A2. Mix the ingredients of Table 1 into a second mixture; heat up the second mixture until the second mixture reaches a second melting temperature and melts; with a second mold, form the melted second mixture into the body part 110 of the two-part artificial nail 100 via a process of extrusion or injection molding which is operated at a second molding temperature. Preferably, the second molding temperature is kept substantially the same as or above the second melting temperature.
Step A3. Attach the decoration part 120, obtained in Step A1, to the body part 110, obtained in Step A2, to form the complete artificial nail 100.

It is to be noted that, in Method A, Step A1 and Step A2 may be performed concurrently or sequentially. Step A3 is then performed with both the decoration part 120 and the body part 110 already fabricated and available, i.e., after Step A1 and Step A2 are both performed.

An alternative method (hereinafter, “Method B”) of making the two-part artificial nail 100 is also described herein, wherein the body part 110 and the decoration part 120 are made sequentially rather than concurrently. In particular, the fabrication of the body part 110 follows the fabrication of the decoration part 120, and the engagement between the two parts is achieved in-situ during the fabrication of the body part 110. Method B may include the following steps:
Step B1. Mix the ingredients of Table 2 into a first mixture; heat up the first mixture until the first mixture reaches a first melting temperature and melts; with a first mold, form the melted first mixture into the decoration part 120 of the two-part artificial nail 100 via a process of extrusion or injection molding which is operated at a first molding temperature. Preferably, the first molding temperature is kept substantially same or above the first melting temperature.
Step B2. Mix the ingredients of Table 1 into a second mixture; heat up the second mixture until the second mixture reaches a second melting temperature and melts.
Step B3. Place the decoration part 120 obtained in Step B1 in a second mold; with the second mold containing the decoration part 120, additively form, via a process of extrusion or injection molding operated at a second molding temperature, the melted second mixture obtained in Step B2 into the body part 110 of the two-part artificial nail 100, wherein the body part 110 is thereby connected or otherwise engaged with the decoration part 120 (e.g., with the bonding area 115 bonded to the inner surface 125) in the second mold, resulting in the two-part artificial nail 100. Preferably, the second molding temperature is kept at substantially the same or above the second melting temperature but below the first melting temperature.

Preferably, the body part 110 of the two-part artificial nail 100 may substantially have a flexural modulus of 1000-1999 MPa. In contrast, the decoration part 120 of the two-part artificial nail 100 may substantially have a flexural modulus of 2000-5000 MPa. That is, the decoration part 120, which is obtained in Step A1 or Step B1, is preferred to have a flexural modulus higher than that of the body part 110, which is obtained in Step A2 or Step B3. A higher flexural modulus indicates a harder physical property as compared to a lower flexural modulus. Namely, the decoration part 120 is preferred to have a harder physical property as compared to the body part 110.

In Method A, the body part 110 and the decoration part 120 are obtained in Step A1 and Step A2, respectively, and then engaged with one another in Step A3. The engagement interface, such as the interface between the bonding area 115 and the inner surface 125, may utilize certain engagement features to enhance the engagement. The engagement features may include a mechanical structure that increases a total surface area of the interface between the decoration part 120 and the body part 110. The increased interface area helps to form a stronger bonding between the two parts in Step A3. The engagement features may be formed on either or both of the body part 110 and the decoration part 120. For example, in Step A1, teeth or a steps-like structure may be formed on the inner surface 125 of the decoration part 120. Alternatively or additionally, teeth or a steps-like structure may be formed on the bonding area 115 of the body part 110 in Step A2. The teeth and/or the steps-like structure serve the purpose of enhancing the engagement between the body part 110 and the decoration part 120 by increasing the total surface area the interface therebetween, where adhesive is applied. In some embodiments, corresponding engagement features may be formed on both the bonding area 115 and the inner surface 125.

In Method B, the forming of the decoration part 120 is followed by the forming of the body part 110. Moreover, the decoration part 120 is preferably attached to or otherwise embedded in the body part 110 by filling the melted second mixture to corresponding engagement features on and of the decoration part 110. The engagement features may include a mechanical structure that increases a total surface area of the interface between the decoration part 120 and the body part 110. The increased interface area helps to form a stronger bonding between the two parts in Step B3. For example, the decoration part 120 may be molded in Step B1 to include teeth, or a steps-like structure, on the inner surface 125 such that the total surface area of the inner surface 125 may thereby be increased. This would provide a sufficiently large interface area between the inner surface 125 of the decoration part 120 and the bonding area 115 of the body part 110 such that, when the body part 110 is formed in Step B3, the decoration part 120 and the body part 110 are well bonded to one another to form an integral artificial nail 100.

It is to be noted that, in Step B3, the second mold may be the same mold as, or a different mold from, the first mold, i.e., the mold used in Step B1. That is, in some embodiments, the first mold of Step B1 may be different from the second mold of Step B3, and thus in Step B3 the formed decoration part 120 is required to be transferred from the first mold to the second mold before the body part 110 is formed in the second mold. In contrast, in some alternative embodiments, the first mold of Step B1 may also be used as the second mold of Step B3, in which case Step B3 is performed to the same mold holding the decoration part 120 following the forming of the decoration part 120 in Step B1, wherein a transfer of the decoration part 120 from a mold to another mold is unnecessary.

It is to also be noted that, each of the first and second melting temperatures in Method A and Method B may not be a single, fixed value, but rather a continuous temperature range. The melted mixture (e.g., either the first or second mixture) may start to exhibit a change in its material phase described as “melting” at a low end of the continuous temperature range. The mixture may continue to exhibit the melted condition while the temperature of the mixture continues to rise. A high end of the continuous temperature range may be defined as the molding temperature, i.e., the temperature at which the corresponding molding process is performed.

Each of Method A and Method B of manufacturing the two-part artificial nail, as described above, is easy to perform, particularly with manufacturing conditions that can be well controlled, and thus practical for industrial mass production.

Compared with existing techniques or manufacturing methods, the method of making the artificial nail 100 as described above (i.e., Method A and Method B) exhibits various advantageous features including: (1) Through changing the composition (e.g., the parts by weight) of the ingredients in Table 2 (or Table 1), the melting temperature of the first (or second) mixture, as well as the flexural modulus of the decoration part 120 (or body part 110), may be fine-tuned or otherwise adjusted as manufacturing parameters, thereby resulting in enhanced wear resistance of the artificial nail 100 (e.g., especially the decoration part 120) as well as enhanced bonding or engagement between the body part 110 and the decoration part 120. (2) The inclusion of the filler in the ingredient list of the decoration part 120 (i.e., Table 2) prevents an undesired color cross phenomenon that may otherwise happen during the manufacturing process of the artificial nail 100, particularly in Step B3. (3) The method involves relatively simple techniques that can be easily performed, and particularly excludes post-process painting steps. This results in reduced manufacturing cost, as well as reduced harmful substance intake by the manufacturing personnel. (4) The method is able to produce an artificial nail 100 that has the body part 110 and the decoration part 120 positioned substantially on a same vertical level. As described elsewhere herein above, the method is also capable of producing an artificial nail 100 that has the decoration part 120 positioned at a different vertical level with respect to the body part 110. This freedom of positioning the decoration part 120 differently with respect to the body part 110 enables the resulted artificial nails to fulfill different aesthetical requirements of the users.

### Preferred Embodiment #1

A first preferred embodiment of a two-part artificial nail 100 according to the present disclosure includes a decoration part 120 made from a first mixture via a process of extrusion or injection molding with the first mixture melted at a melting temperature in the range of 230-300° C. The first mixture is formed by uniformly mixing 70 kilograms (kg) of PC, 20 kg of ABS, 4.5 kg of MBS copolymer as a coupling agent, 5 kg of talcum powder, and 0.5 kg of tris(2,4-di-tert-butylphenyl) phosphite as an antioxidant.

The two-part artificial nail 100 further includes a body part 110 made from a second mixture via a process of extrusion or injection molding with the second mixture melted at a melting temperature in the range of 180-220° C. The second mixture is formed by uniformly mixing 90 kg of ABS, 5 kg of TPU, 2.5 kg of MBS copolymer as a coupling agent, 2 kg of DOTP as a toughening agent, and 0.5 kg of tris(2,4-di-tert-butylphenyl) phosphite as an antioxidant.

### Preferred Embodiment #2

A second preferred embodiment of a two-part artificial nail 100 according to the present disclosure includes a decoration part 120 made from a first mixture via a process of extrusion or injection molding with the first mixture melted at a melting temperature in the range of 235-305° C. The first mixture is formed by uniformly mixing 65 kg of PC, 20 kg of ABS, 4.5 kg of MBS copolymer as a coupling agent, 10 kg of talcum powder, and 0.5 kg of tris(2,4-di-tert-butylphenyl) phosphite as an antioxidant.

The two-part artificial nail 100 further includes a body part 110 made from a second mixture via a process of extrusion or injection molding with the second mixture melted at a melting temperature in the range of 175-215° C. The second mixture is formed by uniformly mixing 85 kg of ABS, 10 kg of TPU, 2.5 kg of MBS copolymer as a coupling agent, 2 kg of DOTP as a toughening agent, and 0.5 kg of tris(2,4-di-tert-butylphenyl) phosphite as an antioxidant.

### Preferred Embodiment #3

A third preferred embodiment of a two-part artificial nail 100 according to the present disclosure includes a decoration part 120 made from a first mixture via a process of extrusion or injection molding with the first mixture melted at a melting temperature in the range of 240-310° C. The first mixture is formed by uniformly mixing 60 kg of PC, 20 kg of ABS, 4.5 kg of MBS copolymer as a coupling agent, 15 kg of talcum powder, and 0.5 kg of tris(2,4-di-tert-butylphenyl) phosphite as an antioxidant.

The two-part artificial nail 100 further includes a body part 110 made from a second mixture via a process of extrusion or injection molding with the second mixture melted at a melting temperature in the range of 170-210° C. The second mixture is formed by uniformly mixing 80 kg of ABS, 15 kg of TPU, 2.5 kg of MBS copolymer as a coupling agent, 2 kg of DOTP as a toughening agent, and 0.5 kg of tris(2,4-di-tert-butylphenyl) phosphite as an antioxidant.

### Preferred Embodiment #4

A fourth preferred embodiment of a two-part artificial nail 100 according to the present disclosure includes a decoration part 120 made from a first mixture via a process of extrusion or injection molding with the first mixture melted at a melting temperature in the range of 245-315° C. The first mixture is formed by uniformly mixing 55 kg of PC, 20 kg of ABS, 4.5 kg of MBS copolymer as a coupling agent, 20 kg of talcum powder, and 0.5 kg of tris(2,4-di-tert-butylphenyl) phosphite as an antioxidant.

The two-part artificial nail 100 further includes a body part 110 made from a second mixture via a process of extrusion or injection molding with the second mixture melted at a melting temperature in the range of 165-205° C. The second mixture is formed by uniformly mixing 75 kg of ABS, 20 kg of TPU, 2.5 kg of MBS copolymer as a coupling agent, 2 kg of DOTP as a toughening agent, and 0.5 kg of tris(2,4-di-tert-butylphenyl) phosphite as an antioxidant.

### Preferred Embodiment #5

A fifth preferred embodiment of a two-part artificial nail 100 according to the present disclosure includes a decoration part 120 made from a first mixture via a process of extrusion or injection molding with the first mixture melted at a melting temperature in the range of 250-320° C. The first mixture is formed by uniformly mixing 50 kg of PC, 20 kg of ABS, 4.5 kg of MBS copolymer as a coupling agent, 25 kg of talcum powder, and 0.5 kg of tris(2,4-di-tert-butylphenyl) phosphite as an antioxidant.

The two-part artificial nail 100 further includes a body part 110 made from a second mixture via a process of extrusion or injection molding with the second mixture melted at a melting temperature in the range of 160-200° C. The second mixture is formed by uniformly mixing 70 kg of ABS, 25 kg of TPU, 2.5 kg of MBS copolymer as a coupling agent, 2 kg of DOTP as a toughening agent, and 0.5 kg of tris(2,4-di-tert-butylphenyl) phosphite as an antioxidant.

### Comparative Embodiment #1

For the purpose of comparison, a first comparative embodiment of a two-part artificial nail 100 is made. The first comparative embodiment includes a decoration part 120 made from a first mixture via a process of extrusion or injection molding with the first mixture melted at a melting temperature in the range of 230-300° C. The first mixture is formed by uniformly mixing 70 kg of PC, 25 kg of ABS, 4.5 kg of MBS copolymer as a coupling agent, 5 kg of talcum powder, and 0.5 kg of tris(2,4-di-tert-butylphenyl) phosphite as an antioxidant.

The first comparative embodiment further includes a body part 110 made from a second mixture via a process of extrusion or injection molding with the second mixture melted at a melting temperature in the range of 220-235° C. The second mixture is formed by uniformly mixing 95 kg of ABS, 2.5 kg of MBS copolymer as a coupling agent, 2 kg of DOTP as a toughening agent, and 0.5 kg of tris(2,4-di-tert-butylphenyl) phosphite as an antioxidant.

### Comparative Embodiment #2

For the purpose of comparison, a second comparative embodiment of a two-part artificial nail 100 is made. The second comparative embodiment includes a decoration part 120 made from a first mixture via a process of extrusion or injection molding with the first mixture melted at a melting temperature in the range of 210-250° C. The first mixture is formed by uniformly mixing 75 kg of PC, 20 kg of ABS, 4.5 kg of MBS copolymer as a coupling agent, and 0.5 kg of tris(2,4-di-tert-butylphenyl) phosphite as an antioxidant.

The second comparative embodiment further includes a body part 110 made from a second mixture via a process of extrusion or injection molding with the second mixture melted at a melting temperature in the range of 180-220° C. The second mixture is formed by uniformly mixing 90 kg of ABS, 5 kg of TPU, 2.5 kg of MBS copolymer as a coupling agent, 2 kg of DOTP as a toughening agent, and 0.5 kg of tris(2,4-di-tert-butylphenyl) phosphite as an antioxidant.

### Performance Comparison of Preferred and Comparative Embodiments

To illustrate the advantages of the preferred embodiments of the present disclosure, performance comparison is made between the experimental group (i.e., the preferred embodiments #1-#5) and the control group (i.e., the comparative embodiments #1 and #2), with the result shown in Table 3 below. Performance indices tested includes modulus (i.e., flexural modulus), color cross, and wear resistance. Specifically, the modulus index is tested according to the international ASTM D790 standard using a universal tester, with a sample size of 127 mm×12.7 mm×3.2 mm, at a test speed of 15 mm/min, and under an ambient condition of 23+/−2° C. in temperature and 50+/−5% RH in relative humidity. The color cross situation is determined by visual inspection. The wear resistance (i.e., resistance to surface abrasion) is tested according to the international ASTM D1044-2013 standard, classified as Grade 1 (least resistant), Grade 2, Grade 3, Grade 4, or Grade 5 (most resistant). In particular, material exhibiting a coefficient of friction larger than 0.50 is classified as Grade 1, in the range of 0.31-0.50 as Grade 2, in the range of 0.21-0.30 as Grade 3, in the range of 0.11-0.20 as Grade 4, and less than 0.10 as Grade 5.

TABLE 3

| | | | Color cross at | |
|---|---|---|---|---|
| | | | interface | Decoration |
| | Body part | Decoration | between body | part |
| | modulus | part modulus | part and | resistance |
| | (MPa) | (MPa) | decoration part | to abrasion |
| Preferred | 1900 | 4050 | No color cross | Grade 3 |
| Embodiment | | | observed | |
| #1 | | | | |
| Preferred | 1750 | 4300 | No color cross | Grade 4 |
| Embodiment | | | observed | |
| #2 | | | | |
| Preferred | 1600 | 4550 | No color cross | Grade 4 |
| Embodiment | | | observed | |
| #3 | | | | |
| Preferred | 1450 | 4700 | No color cross | Grade 5 |
| Embodiment | | | observed | |
| #4 | | | | |
| Preferred | 1200 | 4850 | No color cross | Grade 5 |
| Embodiment | | | observed | |
| #5 | | | | |
| Comparative | 2500 | 2700 | Color cross | Grade 2 |
| Embodiment | | | presented | |
| #1 | | | | |
| Comparative | 2450 | 2650 | Color cross | Grade 2 |
| Embodiment | | | presented | |
| #2 | | | | |

The test result shown in Table 3 clearly indicates superior performances of the preferred embodiments #1-#5 over those of the comparative embodiments #1 and #2. A few advantages of the two-part artificial nails according to the present disclosure may be concluded from Table 3, including: (1) The body part modulus test result of the preferred embodiments indicates that the body part 110 of the two-part artificial nail 100 becomes more flexible or softer as the ingredient proportion of the TPU resin increases, which also reduces the melting temperature of the second mixture. The softer body part 110 makes the artificial nail 100 more comfortable to wear for users. (2) The decoration part modulus test result of the preferred embodiments indicates that the decoration part 120 of the two-part artificial nail 100 becomes harder and thus more resistant to abrasion as the ingredient proportion of the talcum powder increases, which also increases the melting temperature of the first mixture. The harder decoration part 120 makes the artificial nail 100 more resistant to abrasion (i.e., having higher wear resistance), whereas the adhesion between the body part 110 and the decoration part 120 also becomes stronger. (3) The test result of the comparative embodiments indicates the importance of the filler (i.e., the talcum powder) and the TPU resin as key ingredients in the artificial nail 100 of the present disclosure. As clearly shown, without the talcum powder as an ingredient, the melting temperature of the first mixture is reduced. In addition, without the TPU resin as an ingredient, the melting temperature of the second mixture is increased. This gives rise to the undesired color cross phenomenon as observed, as well as reduced resistance to abrasion, in the comparative embodiments. In view of the above, the two-part artificial nails according to the present disclosure exhibit a more optimized ingredient selection and composition, which is more practical and beneficial for manufacturing long-lasting, high-performance, and aesthetically attractive two-part and/or dual-color artificial nails.

### Illustrative Process

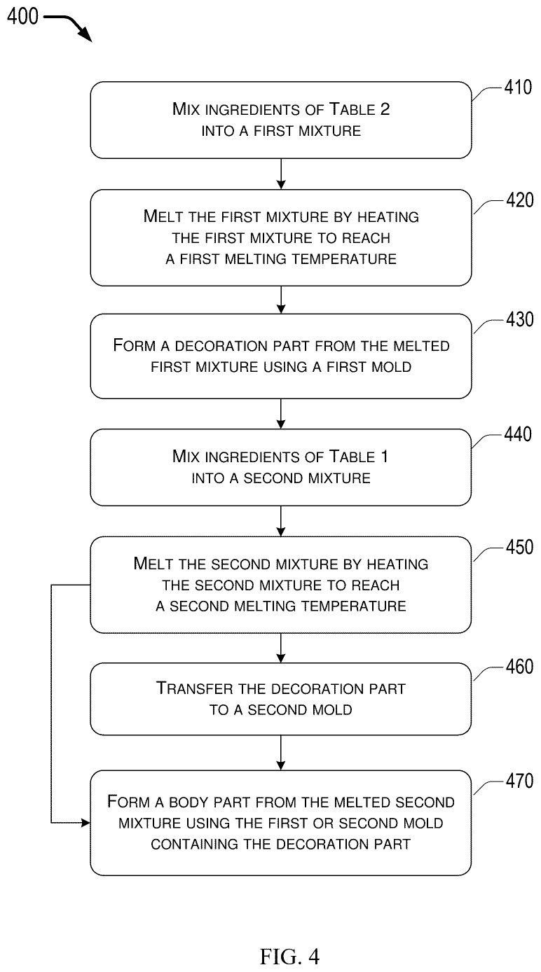

FIG. 4 illustrates an example process 400 in accordance with an implementation of the present disclosure. Process 400 may be an example implementation of a method described above whether partially or completely with respect to making or manufacturing a two-part artificial nail in accordance with the present disclosure. Process 400 may represent an aspect of implementation of features of the artificial nail 100. Process 400 may include one or more operations, actions, or functions as illustrated by blocks 410, 420, 430, 440, 450, 460 and 470. Although illustrated as discrete blocks, various blocks of process 400 may be divided into additional blocks, combined into fewer blocks, or eliminated, depending on the desired implementation. Furthermore, one or more of the blocks/sub-blocks of process 400 may be executed repeatedly or iteratively. Process 400 may begin at block 410.

At block 410, process 400 may involve mixing the ingredients of Table 2 into a first mixture, wherein the first mixture has a first melting temperature. In some embodiments, each of polymer C and polymer D of Table 2 may be one or more of ABS, AS, PMMA, PC, PE, PA and PS. For example, the first mixture may include both PC and ABS. The first mixture may also include talcum powder as the filler, MBS copolymer as a coupling agent, as well as tris(2,4-di-tert-butylphenyl) phosphite as an antioxidant. Process 400 may proceed from block 410 to block 420.

At block 420, process 400 may involve melting the first mixture obtained at block 410 to a melted state. Specifically, the first mixture may be heated until its temperature reaches the first melting temperature, and thus melts to have a texture or physical state that is suitable for a molding process which is to take place at block 430. Process 400 may proceed from block 420 to block 430.

At block 430, process 400 may involve forming a decoration part of an artificial nail (e.g., the decoration part 120 of the artificial nail 100) from the melted first mixture obtained at block 420. The forming of the decoration part is achieved through a first molding process, which may be a process of extrusion or injection molding. For instance, the first molding process may be operated using a first mold; with the melted first mixture kept at a first molding temperature, the melted first mixture is injected or extruded into the first mold. As a result, the decoration part is formed in the first mold. It is to be noted that the first molding temperature may be a constant temperature or a varying temperature that is the same or above the first melting temperature of block 420. Process 400 may proceed from block 430 to block 440.

At block 440, process 400 may involve mixing the ingredients of Table 1 into a second mixture, wherein the second mixture has a second melting temperature. Preferably, the second melting temperature (i.e., a property of the second mixture) is lower than the first melting temperature (i.e., a property of the first mixture). In some embodiments, each of polymer A and polymer B of Table 1 may be one or more of ABS, AS, PMMA, PE, PA, PS, TPU, TPE and TPR. For example, the second mixture may include both TPU and ABS. The second mixture may also include DOTP as a toughening agent, MBS copolymer as a coupling agent, as well as tris(2,4-di-tert-butylphenyl) phosphite as an antioxidant. Process 400 may proceed from block 440 to block 450.

At block 450, process 400 may involve melting the second mixture obtained at block 440 to a melted state. Specifically, the second mixture may be heated until its temperature reaches the second melting temperature, and thus melts to have a texture or physical state suitable for a molding process that is to take place at block 470. Preferably, the second melting temperature is lower than the first melting temperature of block 420. In some embodiments where two separate molds are used in process 400, i.e., one mold at block 430 and the other mold at block 470, process 400 may proceed from block 450 to block 460. In some other embodiments where a single mold is used at both block 430 and block 470, process 400 may proceed from block 450 to block 470.

At block 460, process 400 may involve transferring the decoration part formed at block 430 from the first mold to a second mold that is different from the first mold. The second mold may include receptacles or fixtures to receive and hold the decoration part in the second mold for the operation of another molding process that is to take place at block 470. Process 400 may proceed from block 460 to block 470.

At block 470, process 400 may involve forming a body part of the artificial nail (e.g., the body part 110 of the artificial nail 100) from the melted second mixture obtained at block 450. The forming of the body part is achieved through a second molding process, which may be a process of extrusion or injection molding. In an event that process 400 proceeds from block 460 to block 470, the second molding process may be operated using a second mold; in an event that process 400 proceeds directly from block 450 to block 470 without going through block 460, the second molding process may be operated using the first mold, i.e., the same mold used at block 430. In either case, with the melted second mixture kept at a second molding temperature, the melted second mixture is injected or extruded into the mold (i.e., either the first or second mold) that carries the decoration part, which has been formed at block 430. As a result, the body part is additively formed in the mold, wherein the body part is thereby connected or otherwise engaged with the decoration part (e.g., the bonding area 115 of the body part 110 being bonded to the inner surface 125 of the decoration part 120), resulting in the two-part artificial nail. It is to be noted that the second molding temperature may be a constant temperature or a varying temperature that is the same as or above the second melting temperature of block 450. In addition, during the operation of the second molding process, the second molding temperature is kept lower than the first molding temperature of block 430. Preferably, during the operation of the second molding process, the second molding temperature is kept lower than the first melting temperature of the first mixture.

It should be noted that any modification made by a person skilled in the art to the embodiments disclosed in the present disclosure would still be considered within the scope of the claims of the present application. Accordingly, the scope of the claims of the present application is not limited to the foregoing embodiments.

What is claimed is:

1. An artificial nail, comprising:
a decoration part made from a first mixture having a first melting temperature, the decoration part being formed using a first molding process; and
a body part made from a second mixture having a second melting temperature, the body part being formed using a second molding process,
wherein the second melting temperature is lower than the first melting temperature.

2. The artificial nail of claim 1, wherein the first mixture comprises a first resin polymer and a filler.

3. The artificial nail of claim 2, wherein the first mixture further comprises a toughening agent and an antioxidant.

4. The artificial nail of claim 2, wherein the filler comprises one or more of calcium carbonate, talcum powder, and barium sulfate.

5. The artificial nail of claim 2, wherein the first resin polymer comprises one or more of acrylonitrile butadiene styrene (ABS), acrylonitrile styrene (AS), polymethyl methacrylate (PMMA), polycarbonate (PC), polyethylene (PE), polyamide (PA) and polystyrene (PS).

6. The artificial nail of claim 2, wherein:
the first resin polymer comprises acrylonitrile butadiene styrene (ABS) and polycarbonate (PC), and
the second mixture comprises ABS and thermoplastic polyurethane (TPU).

7. The artificial nail of claim 1, wherein the second mixture comprises thermoplastic polyurethane (TPU) and a second resin polymer.

8. The artificial nail of claim 7, wherein the second resin polymer comprises one or more of acrylonitrile butadiene styrene (ABS), acrylonitrile styrene (AS), polymethyl methacrylate (PMMA), thermoplastic elastomer (TPE), polyethylene (PE), polyamide (PA) and polystyrene (PS).

9. The artificial nail of claim 7, wherein the second mixture further comprises a toughening agent, a coupling agent and an antioxidant.

10. The artificial nail of claim 1,
wherein the first mixture comprises:
55-95 parts of polycarbonate (PC);
5-45 parts of acrylonitrile butadiene styrene (ABS);
3-30 parts of talcum powder;
2-10 parts of a first coupling agent; and
0.3-1 part(s) of a first antioxidant, and
wherein the second mixture comprises:
55-95 parts of ABS;
5-45 parts of thermoplastic polyurethane (TPU);
2-10 parts of a toughening agent;
2-10 parts of a second coupling agent; and
0.3-1 part(s) of a second antioxidant.

11. The artificial nail of claim 10, wherein the toughening agent comprises one or more of dioctyl phthalate (DOTP), acetyl tributyl citrate (ATBC) and chlorinated polyethylene (CPE).

12. The artificial nail of claim 10, wherein each of the first coupling agent and the second coupling agent comprises a copolymer made based on methyl methacrylate (MMA), butadiene, and styrene.

13. The artificial nail of claim 10, wherein each of the first antioxidant and the second antioxidant comprises one or both of tris(2,4-di-tert-butylphenyl) phosphite and N,N-Hexamethylene bis(3,5-ditert-butyl-4-hydroxyphenyl propionamide).

14. The artificial nail of claim 1, wherein the decoration part, compared to the body part, is positioned further away in a vertical direction from a top surface of a human nail capable of wearing the artificial nail, and wherein the vertical direction is defined as a direction substantially normal to and away from the top surface of the human nail.

15. The artificial nail of claim 1, wherein:
the decoration part has a first flexural modulus,
the body part has a second flexural modulus, and
the first flexural modulus is higher than the second flexural modulus.

16. A method of making an artificial nail, the artificial nail comprising a decoration part and a body part, the method comprising:
melting a first mixture by heating the first mixture to reach a first melting temperature;
forming, in a first mold, the decoration part from the melted first mixture using a first molding process operated at a first molding temperature;
melting a second mixture by heating the second mixture to reach a second melting temperature; and
forming, in a second mold carrying the decoration part, the body part from the melted second mixture using a second molding process operated at a second molding temperature,
wherein:
the second melting temperature is lower than the first melting temperature, and
the second molding temperature is lower than the first melting temperature.

17. The method of claim 16, wherein the forming of the body part comprises bonding the body part to the decoration part to form the artificial nail.

18. The method of claim 17, wherein the bonding of the body part to the decoration part comprises positioning a top surface of the decoration part higher than a top surface of the body part in a vertical direction substantially normal to the top surface of the body part.

19. The method of claim 16, wherein the first mixture comprises a first resin polymer and a filler, and wherein the second mixture comprises a second resin polymer and thermoplastic polyurethane (TPU).

20. The method of claim 16, wherein the second mold is the first mold.

21. An artificial nail, comprising:
a decoration part made from a first mixture and exhibiting a first flexural modulus; and
a body part made from a second mixture and exhibiting a second flexural modulus,
wherein the second flexural modulus is lower than the first flexural modulus.

22. The artificial nail of claim 21,
wherein the first mixture comprises:
55-95 parts of polycarbonate (PC);
5-45 parts of acrylonitrile butadiene styrene (ABS);
3-30 parts of talcum powder;
2-10 parts of a first coupling agent; and
0.3-1 part(s) of a first antioxidant, and
wherein the second mixture comprises:
55-95 parts of ABS;
5-45 parts of thermoplastic polyurethane (TPU);
2-10 parts of a toughening agent;
2-10 parts of a second coupling agent; and
0.3-1 part(s) of a second antioxidant.

23. The artificial nail of claim 21, wherein engagement features are formed at an interface between the decoration part and the body part, and wherein the engagement features are formed on either or both of the decoration part and the body part.
